(19) United States
(12) Patent Application Publication
(10) Pub. No.: US 2014/0055572 A1
(43) Pub. Date: Feb. 27, 2014

(54) IMAGE PROCESSING APPARATUS FOR A VEHICLE

(71) Applicants: Noriaki Shirai, Chiryu-shi (JP); Masaki Masuda, Kariya-shi (JP)

(72) Inventors: Noriaki Shirai, Chiryu-shi (JP); Masaki Masuda, Kariya-shi (JP)

(73) Assignee: DENSO CORPORATION, Kariya-city, Aichi-pref. (JP)

(21) Appl. No.: 14/110,066

(22) PCT Filed: Apr. 2, 2012
(86) PCT No.: PCT/JP2012/058811

§ 371 Date: Nov. 14, 2013

(30) Foreign Application Priority Data
Apr. 6, 2011 (JP) 2011-084565

(51) Int. Cl. H04N 13/02

(52) U.S. Cl. CPC H04N 13/02
USPC 348/47

(57) ABSTRACT

An image processing apparatus for a vehicle characterized in that the apparatus includes a first imaging section, a second imaging section, a switching section which switches exposure controls of the first imaging section and the second imaging section to an exposure control for recognizing an object placed on a road and a lamp or to an exposure control for recognizing a three-dimensional object, and a detection section which detects the object placed on a road and the lamp or the three-dimensional object from images captured by the first imaging section and the second imaging section, wherein under the exposure control for recognizing an object placed on a road and a lamp, exposure of the first imaging section and exposure of the second imaging section are different from each other.

### TECHNICAL FIELD

The present invention relates to an image processing apparatus for a vehicle which processes a captured image to detect a three-dimensional object, an object placed on a road, or a lamp.

### BACKGROUND ART

An image processing apparatus for a vehicle is known which detects a three-dimensional object, an object placed on a road (e.g. a lane, a sign), or a lamp (e.g. headlights, taillights of a vehicle) from an image around the vehicle captured by a camera to support vehicle operation by the driver (refer to patent document 1). The image processing apparatus for a vehicle disclosed in the patent document 1 uses an exposure control of two cameras configuring a stereo camera as an exposure control for a three-dimensional object to detect a three-dimensional object. In addition, an exposure control of one of the two cameras is used as an exposure control for detecting a white line to detect a white line.

### PRIOR ART DOCUMENTS

### Patent Documents

PATENT DOCUMENT 1

JP-A-2007-306272

### SUMMARY OF THE INVENTION

### Problems to be Solved by the Invention

According to the image processing apparatus for a vehicle disclosed in the patent document 1, in a place where light-dark change is considerable such as an exit and an entrance of a tunnel, a white line may not be detected when trying to detect the white line from an image captured by one camera because of a lack of a dynamic range of the image.

The present invention has been made in light of the points set forth above and has as its object to provide an image processing apparatus for a vehicle which has a large dynamic range of an image and can reliably detect an object placed on a road, such as a white line, and a lamp.

### Means of Solving the Problems

An image processing apparatus for a vehicle of the present invention is characterized in that the apparatus includes a first imaging section, a second imaging section, a switching section which switches exposure controls of the first imaging section and the second imaging section to an exposure control for recognizing an object placed on a road and a lamp or to an exposure control for recognizing a three-dimensional object, and a detection section which detects the object placed on a road and the lamp or the three-dimensional object from images captured by the first imaging section and the second imaging section, wherein under the exposure control for recognizing an object placed on a road and a lamp, exposure of the first imaging section and exposure of the second imaging section are different from each other.

In the image processing apparatus for a vehicle of the present invention, when detecting an object placed on a road or a lamp, both exposure controls of the first imaging section and the second imaging section are set to an exposure control for recognizing an object placed on a road and a lamp, and exposure of the first imaging section and exposure of the second imaging section are different from each other. Hence, an image captured by the first imaging section and an image captured by the second imaging section have, as a whole, a dynamic range larger than that of an image captured by one of the imaging sections.

Hence, since an object placed on a road or a lamp is detected by using an image captured by the first imaging section and an image captured by the second imaging section, it is difficult to cause a state where the object placed on a road and the lamp cannot be detected due to the lack of the dynamic range of the image.

When the image processing apparatus for a vehicle of the present invention performs the exposure control for recognizing an object placed on a road and a lamp, it is preferable that the first imaging section and the second imaging section simultaneously perform imaging. Thereby, a state is not caused where an image captured by the first imaging section and an image captured by the second imaging section are different from each other due to the difference in the timing of imaging. As a result, an object placed on a road and a lamp can be detected more precisely.

Under the exposure control for recognizing an object placed on a road and a lamp, it is preferable that a dynamic range of the first imaging section and a dynamic range of the second imaging section overlap with each other. Thereby, an area having brightness which cannot be detected is not generated between the dynamic ranges.

For example, an upper limit of the dynamic range of the first imaging section and a lower limit of the dynamic range of the second imaging section can agree with each other. In addition, conversely, a lower limit of the dynamic range of the first imaging section and an upper limit of the dynamic range of the second imaging section can be agreed with each other. In addition, the dynamic range of the first imaging section and the dynamic range of the second imaging section may overlap with each other.

The detection section can combines images captured by the first imaging section and the second imaging section when the exposure control for recognizing an object placed on a road and a lamp is performed, and can detect the object placed on a road or the lamp from the combined image. The dynamic range of the combined image is larger than the dynamic range of the image obtained before combination (the image captured by the first imaging section or the second imaging section). Hence, by using this combined image, it is difficult to cause a state where the object placed on a road and the lamp cannot be detected due to the lack of the dynamic range.

The detection section can select an image having a higher contrast from an image captured by the first imaging section when the exposure control for recognizing an object placed on a road and a lamp is performed and an image captured by the second imaging section when the exposure control for recognizing an object placed on a road and a lamp is performed, and can detect the object placed on a road or the lamp from the selected image. Thereby, it is difficult to cause a state where the object placed on a road and the lamp cannot be detected due to the lack of the dynamic range of the image.

The exposure control for recognizing an object placed on a road and a lamp includes two or more types of controls having different conditions of exposure. The exposure control for recognizing an object placed on a road and a lamp includes exposure controls for detecting a lane (white line), for detecting a sign, for detecting a traffic light, and for detecting lamps.

### BRIEF DESCRIPTION OF THE DRAWINGS

FIG. 1 is a block diagram showing a configuration of a stereo image sensor 1;

FIG. 2 is a flowchart showing a process (whole) performed by the stereo image sensor 1;

FIG. 3 is a flowchart showing an exposure control of a right camera 3;

FIG. 4 is a flowchart showing an exposure control of a left camera 5;

FIG. 5 is an explanatory diagram showing changes in types of exposure controls and in luminance of the right camera 3 and the left camera 5;

FIG. 6 is a flowchart showing a process (whole) performed by the stereo image sensor 1;

FIG. 7 is a flowchart showing a process (whole) performed by the stereo image sensor 1;

FIG. 8 is a flowchart showing an exposure control of the right camera 3;

FIG. 9 is a flowchart showing an exposure control of the left camera 5; and

FIG. 10 is a flowchart showing a process (whole) performed by the stereo image sensor 1.

### EMBODIMENTS FOR CARRYING OUT THE INVENTION

Embodiments of the present invention will be described with reference to the drawings.

### First Embodiment

1. Configuration of the Stereo Image Sensor 1

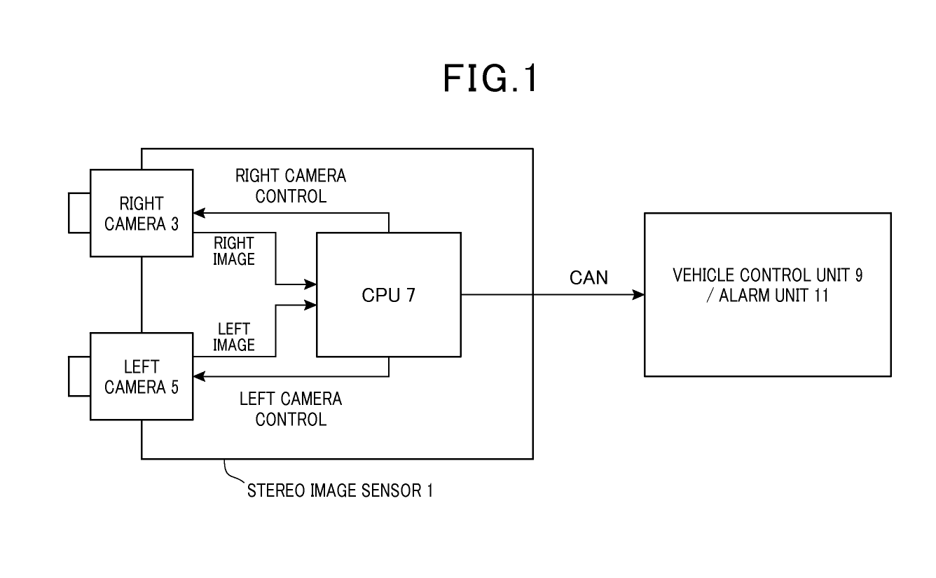

The configuration of the stereo image sensor (image processing apparatus for a vehicle) 1 will be explained based on the block diagram of FIG. 1.

The stereo image sensor 1 is an in-vehicle apparatus installed in a vehicle, and includes a right camera (first imaging section) 3, a left camera (second imaging section) 5, and a CPU (switching section, detection section) 7. The right camera 3 and the left camera 5 individually include a photoelectric conversion element (not shown) such as a CCD, CMOS or the like, and can image the front of the vehicle. In addition, the right camera 3 and the left camera 5 can control exposure by changing exposure time or a gain of an output signal of the photoelectric conversion element. Images captured by the right camera 3 and the left camera 5 are 8 bit data.

The CPU 7 performs control of the right camera 3 and the left camera 5 (including exposure control). In addition, the CPU 7 obtains images captured by the right camera 3 and the left camera 5 and detects a three-dimensional object, an object placed on a road, and a lamp from the images. Note that processes performed by the CPU 7 will be described later.

The CPU 7 outputs detection results of the three-dimensional object, the object placed on a road, and the lamp to a vehicle control unit 9 and an alarm unit 11 via a CAN (in-vehicle communication system). The vehicle control unit 9 performs known processes such as crash avoidance and lane keeping based on the output of the CPU 7. In addition, the alarm unit 11 issues an alarm about a crash or lane departure based on an output from the stereo image sensor 1.

2. Process Performed by the Stereo Image Sensor 1

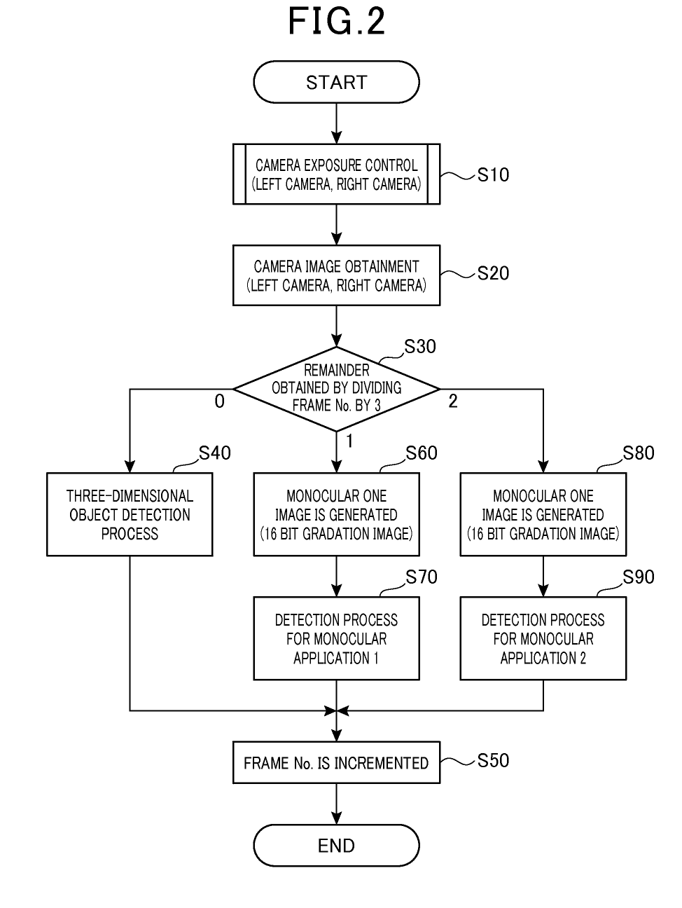

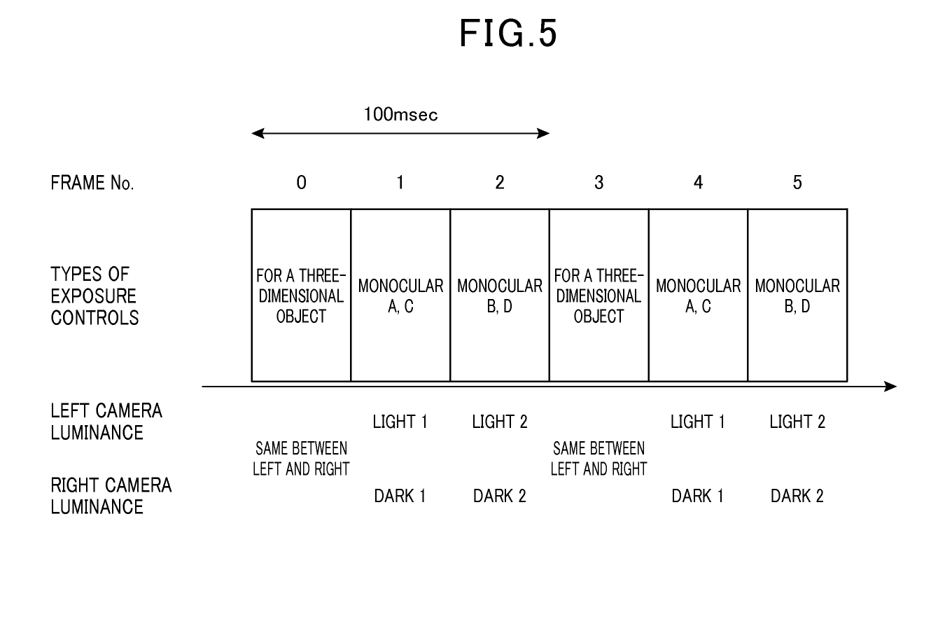

The process performed by the stereo image sensor 1 (especially, the CPU 7) is explained based on the flowcharts in FIGS. 2 to 4 and the explanatory diagram in FIG. 5.

The stereo image sensor 1 repeats the process shown in the flowchart in FIG. 2 at intervals of 33 msec.

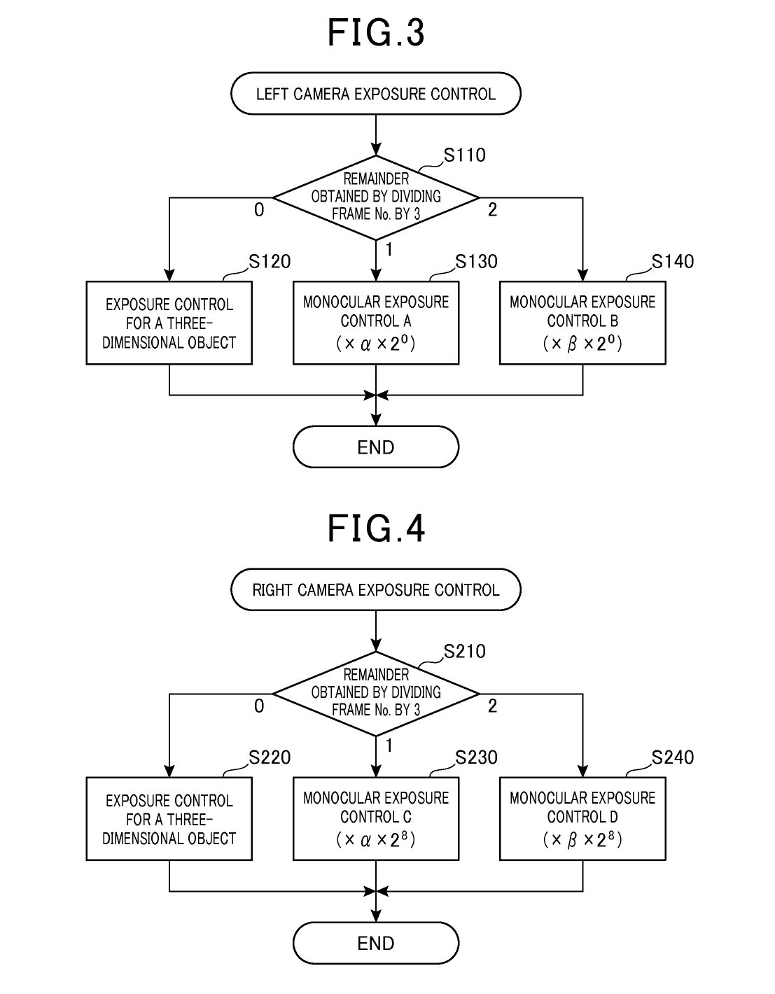

In step 10, exposure controls of the right camera 3 and the left camera 5 are performed. First, the exposure control of the left camera 5 is explained based on the flowchart in FIG. 3. In step 110, a frame No. of an image captured most recently is obtained to calculate X which is a remainder (any one of 0, 1, 2) obtained when dividing the frame No. by 3. Here, the frame No. is a number added to an image (frame) captured by the left camera 5. The frame No. starts from 1 and is incremented by one. For example, if the left camera 5 performs imaging n times, the frame Nos. added to the n images (frames) are 1, 2, 3, 4, 5 . . . n. For example, the value of X is 1 if the frame No. of an image captured most recently is 1, 4, 7, . . . . The value of X is 2 if the frame No. of an image captured most recently is 2, 5, 8, . . . . The value of X is 0 if the frame No. of an image captured most recently is 3, 6, 9, . . . .

If the value of X is 0, the process proceeds to step 120, in which an exposure control for a three-dimensional object is set for the left camera 5. This exposure control for a three-dimensional object is an exposure control suited for a three-dimensional object detection process described later.

Meanwhile, if the value of X is 1, the process proceeds to step 130, in which a monocular exposure control (a type of exposure control for recognizing an object placed on a road and a lamp) A is set for the left camera 5. This monocular exposure control A is a control for setting exposure of the left camera 5 to be exposure suited for recognizing a lane (white line) on a road. In addition, under the monocular exposure control A, brightness of an image is expressed by α×2°.

In addition, if the value of X is 2, the process proceeds to step 140, in which a monocular exposure control (a type of exposure control for recognizing an object placed on a road and a lamp) B is set for the left camera 5. This monocular exposure control B is a control for setting exposure of the left camera 5 to be exposure suited for recognizing a sign. In addition, under the monocular exposure control B, brightness of an image is expressed by β×2°. This β is different from α.

Next, the exposure control of the right camera 3 is shown in the flowchart in FIG. 4.

In step 210, a frame No. of an image captured most recently is obtained to calculate X which is a remainder (any one of 0, 1, 2) obtained when dividing the frame No. by 3. Note that the right camera 3 and the left camera 5 simultaneously perform imaging at any time. Hence, the frame No. of an image captured by the right camera 3 most recently is the same as the frame No. of an image captured by the left camera 5 most recently.

If the value of X is 0, the process proceeds to step 220, in which an exposure control for a three-dimensional object is set for the right camera 3. This exposure control for a three-dimensional object is an exposure control suited for the three-dimensional object detection process described later.

Meanwhile, if the value of X is 1, the process proceeds to step 230, in which a monocular exposure control (a type of exposure control for recognizing an object placed on a road and a lamp) C is set for the right camera 3. This monocular exposure control C is a control for setting exposure of the right camera 3 to be exposure suited for recognizing a lane (white line) on a road. In addition, under the monocular exposure control C, brightness of an image is expressed by α×2⁸ and is 256 times higher than the brightness (α×2⁰) under the monocular exposure control A.

In addition, if the value of X is 2, the process proceeds to step 240, in which a monocular exposure control (a type of exposure control for recognizing an object placed on a road and a lamp) D is set for the right camera 3. This monocular exposure control D is a control for setting exposure of the right camera 3 to be exposure suited for recognizing a sign. In addition, under the monocular exposure control D, brightness of an image is expressed by β×2⁸ and is 256 times higher than the brightness (α×2⁰) under the monocular exposure control B.

Returning to FIG. 2, in step 20, the front of the vehicle is imaged by the right camera 3 and the left camera 5 to obtain images thereof. Note that the right camera 3 and the left camera 5 simultaneously perform imaging.

In step 30, it is determined whether X calculated in the immediately preceding steps 110 and 210 is 0, 1, or 2. If X is 0, the process proceeds to step 40, in which the three-dimensional object detection process is performed. Note that the case where X is 0 is a case where each of the exposure controls of the right camera 3 and the left camera 5 is set to the exposure control for a three-dimensional object, and imaging is performed under the condition thereof.

The three-dimensional object detection process is a known process according to an image processing program for detecting a three-dimensional object from an image captured by stereovision technology. In the three-dimensional object detection process, correlation is obtained between a pair of images captured by the right camera 3 and the left camera 5 arranged from side to side, and a distance to the same object in a manner of triangulation based on a parallax with respect to the object. Specifically, the CPU 7 extracts portions in which the same imaging object is imaged from a pair of stereo images captured by the right camera 3 and the left camera 5, and makes correspondence of the same point of the imaging object between the pair of stereo images. The CPU 7 obtains the amount of displacement (parallax) between the points subject to correspondence (at a corresponding point) to calculate the distance to the imaging object. In a case where the imaging object exists on the front, if superimposing the image captured by the right camera 3 on the image captured by the left camera 5, the imaging objects are displaced from each other in the right and left, lateral direction. Then, while shifting one of the images by one pixel, the position is obtained where the imaging objects best overlap each other. At this time, the number of shifted pixels is defined as n. If defining the focal length of the lens as f, the distance between the optical axes as m, and the pixel pitch as d, the distance L to the imaging object is established as a relational expression: L=(f×m)/(n×d). This (n×d) is parallax.

In step S50, the frame No. is incremented by one.

Meanwhile, if it is determined that X is 1 in the step 30, the process proceeds to step 60. Note that the case where X is 1 is a case where, in the steps 130, 230, exposure controls of the right camera 3 and the left camera 5 are set to the monocular exposure controls C, A to perform imaging under the conditions thereof.

In step 60, an image (image captured under the monocular exposure control C) captured by the right camera 3 and an image (image captured under the monocular exposure control A) captured by the left camera 5 are combined to generate a synthetic image P. The synthetic image P is generated by summing a pixel value of each pixel of the image captured by the right camera 3 and a pixel value of each pixel of the image captured by the left camera 5 for each pixel. That is, the pixel value of each of the pixels of the synthetic image P is the sum of the pixel value of the corresponding pixel of the image captured by the right camera 3 and the pixel value of the corresponding pixel of the image captured by the left camera 5.

Each of the image captured by the right camera 3 and the image captured by the left camera 5 is 8 bit data. Brightness of the image captured by the right camera 3 is 256 times higher than brightness of the image captured by the left camera 5. Hence, each pixel value of the image captured by the right camera 3 is summed after the pixel value is multiplied by 256. As a result, the synthetic image P combined as describe above becomes 16 bit data. The magnitude of the dynamic range of the synthetic image P is 256 times larger compared with the image captured by the right camera 3 or the image captured by the left camera 5.

Note that since the position of the right camera 3 and the position of the left camera 5 are slightly displaced from each other, the combination of the image captured by the right camera 3 and the image captured by the left camera 5 is performed after one or both of the images are corrected. Since correspondence has been made between the left image and the right image by the three-dimensional object detection process (stereo process), the correction can be performed based on the result of the stereo process. This process is similarly performed when images are combined in step 80 described later.

In step 70, a process is performed in which a lane (white line) is detected from the synthetic image P combined in the step 60. Specifically, in the synthetic image P, points at which the variation of brightness is equal to or more than a predetermined value (edge points) are retrieved to generate an image of the edge points (edge image). Then, in the edge image, a lane (white line) is detected from a shape of an area formed with the edge points by a known technique such as matching. Note that “monocular application 1” in step 70 in FIG. 2 means an application for detecting a lane.

After step 70 is completed, the process proceeds to step 50, in which the frame No. is incremented by one.

Meanwhile, if it is determined that X is 2 in the step 30, the process proceeds to step 80. Note that the case where X is 2 is a case where, in the steps 140, 240, exposure controls of the right camera 3 and the left camera 5 are set to the monocular exposure controls D, B to perform imaging under the conditions thereof.

In step 80, an image (image captured under the monocular exposure control D) captured by the right camera 3 and an image (image captured under the monocular exposure control B) captured by the left camera 5 are combined to generate a synthetic image Q. The synthetic image Q is generated by summing a pixel value of each pixel of the image captured by the right camera 3 and a pixel value of each pixel of the image captured by the left camera 5 for each pixel. That is, the pixel value of each of the pixels of the synthetic image Q is the sum of the pixel value of the corresponding pixel of the image captured by the right camera 3 and the pixel value of the corresponding pixel of the image captured by the left camera 5.

Each of the image captured by the right camera 3 and the image captured by the left camera 5 is 8 bit data. Brightness of the image captured by the right camera 3 is 256 times higher than the brightness of the image captured by the left camera 5. Hence, each pixel value of the image captured by the right camera 3 is summed after the pixel value is multiplied by 256. As a result, the synthetic image Q combined as describe above becomes 16 bit data. The magnitude of the dynamic range of the synthetic image Q is 256 times larger compared with the image captured by the right camera 3 or the image captured by the left camera 5.

In step 90, a process is performed in which a sign is detected from the synthetic image P combined in the step 80. Specifically, in the synthetic image Q, points at which the variation of brightness is equal to or more than a predetermined value (edge points) are retrieved to generate an image of the edge points (edge image). Then, in the edge image, a sign is detected from a shape of an area formed with the edge points by a known technique such as matching. Note that “monocular application 2” in step 90 in FIG. 2 means an application for detecting a sign.

After step 90 is completed, the process proceeds to step 50, in which the frame No. is incremented by one.

FIG. 5 shows how types of exposure controls and luminance of the right camera 3 and the left camera 5 change as the frame No. increases. In FIG. 5, “light 1”, “light 2”, “dark 1”, “dark 2” are α×2⁸, β×2⁸, α×2⁰, β×2⁰, respectively.

3. Advantages Provided by the Stereo Image Sensor 1

(1) The stereo image sensor 1 combines the image captured by the right camera 3 and the image captured by the left camera 5 to generate the synthetic image P and the synthetic image Q having large dynamic ranges, and detects an object placed on a road (e.g. a lane, a sign) or a lamp (e.g. headlights, taillights and the like of a vehicle) from the synthetic image P and the synthetic image Q. Hence, it is difficult to cause a state where the object placed on a road and the lamp cannot be detected due to the lack of the dynamic range of the image.

(2) Two images used for combination of the synthetic image P and the synthetic image Q are simultaneously captured. Hence, a state is not caused where the two images are different from each other due to the difference in the timing of imaging. As a result of this, an object placed on a road and a lamp can be detected more precisely.

### Second Embodiment

1. Configuration of the Stereo Image Sensor 1

The configuration of the stereo image sensor 1 is similar to that of the first embodiment.

2. Process Performed by the Stereo Image Sensor 1

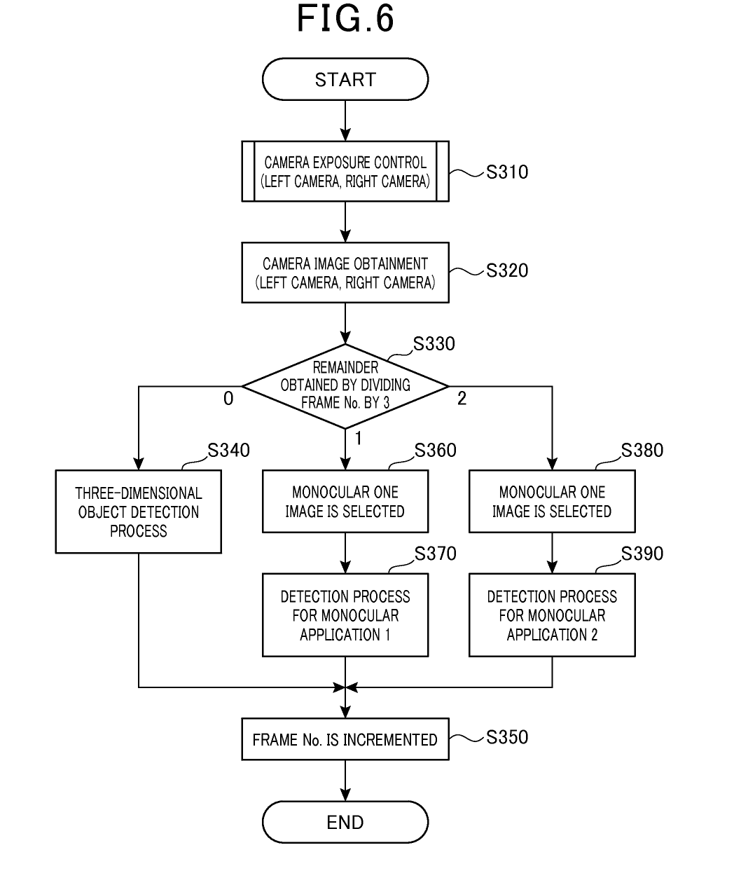

The process performed by the stereo image sensor 1 is explained based on the flowchart in FIG. 6.

The stereo image sensor 1 repeats the process shown in the flowchart in FIG. 6 at intervals of 33 msec.

In step 310, exposure controls of the right camera 3 and the left camera 5 are performed. The exposure controls are similar to those of the first embodiment.

In step 320, the front of the vehicle is imaged by the right camera 3 and the left camera 5 to obtain images thereof. Note that the right camera 3 and the left camera 5 simultaneously perform imaging.

In step 330, a frame No. of an image captured most recently is obtained to determine whether X, which is a remainder obtained when dividing the frame No. by 3, is 0, 1, or 2. If X is 0, the process proceeds to step 340, in which the three-dimensional object detection process is performed. Note that the case where X is 0 is a case where exposure controls of the right camera 3 and the left camera 5 are set to the exposure control for a three-dimensional object, and imaging is performed under the condition thereof. The contents of the three-dimensional object detection process are similar to those of the first embodiment.

In step S350, the frame No. is incremented by one.

Meanwhile, if it is determined that X is 1 in the step 330, the process proceeds to step 360. Note that the case where X is 1 is a case where exposure controls of the right camera 3 and the left camera 5 are respectively set to the monocular exposure controls C, A to perform imaging under the conditions thereof.

In step 360, an image having a higher contrast is selected from an image (image captured under the monocular exposure control C) captured by the right camera 3 and an image (image captured under the monocular exposure control A) captured by the left camera 5. Specifically, the selection is performed as below. In both the image captured by the right camera 3 and the image captured by the left camera 5, points (edge points) at which the variation of brightness is equal to or more than a predetermined value are retrieved to generate an image of the edge points (edge image). Then, the edge image of the image captured by the right camera 3 and the edge image of the image captured by the left camera 5 are compared with each other to determine which edge image has more edge points. Of the image captured by the right camera 3 and the image captured by the left camera 5, the image having more edge points is selected as an image having higher contrast.

In step 370, a process is performed in which a lane (white line) is detected from an image selected in the step 360. Specifically, in the edge image of the selected image, a lane (white line) is detected from a shape of an area formed with the edge points by a known technique such as matching.

After step 370 is completed, the process proceeds to step 350, in which the frame No. is incremented by one.

Meanwhile, if it is determined that X is 2 in the step 330, the process proceeds to step 380. Note that the case where X is 2 is a case where exposure controls of the right camera 3 and the left camera 5 are respectively set to the monocular exposure controls D, B to perform imaging under the conditions thereof.

In step 380, an image having a higher contrast is selected from an image (image captured under the monocular exposure control D) captured by the right camera 3 and an image (image captured under the monocular exposure control B) captured by the left camera 5. Specifically, the selection is performed as below. In both the image captured by the right camera 3 and the image captured by the left camera 5, points (edge points) at which the variation of brightness is equal to or more than a predetermined value are retrieved to generate an image of the edge points (edge image). Then, the edge image of the image captured by the right camera 3 and the edge image of the image captured by the left camera 5 are compared with each other to determine which edge image has more edge points. Of the image captured by the right camera 3 and the image captured by the left camera 5, the image having more edge points is selected as an image having higher contrast.

In step 390, a process is performed in which a sign is detected from an image selected in the step 380. Specifically, in the edge image of the selected image, a sign is detected from a shape of an area formed with the edge points by a known technique such as matching.

After step 390 is completed, the process proceeds to step 350, in which the frame No. is incremented by one.

3. Advantages Provided by the Stereo Image Sensor 1

The stereo image sensor 1 selects an image having higher contrast (an image in which so-called over exposure and under exposure do not occur) from the image captured by the right camera 3 and the image captured by the left camera 5, and detects an object placed on a road or a lamp from the selected image. Hence, it is difficult to cause a state where the object placed on a road and the lamp cannot be detected due to the lack of the dynamic range of the image.

### Third Embodiment

1. Configuration of the Stereo Image Sensor 1

The configuration of the stereo image sensor 1 is similar to that of the first embodiment.

2. Process Performed by the Stereo Image Sensor 1

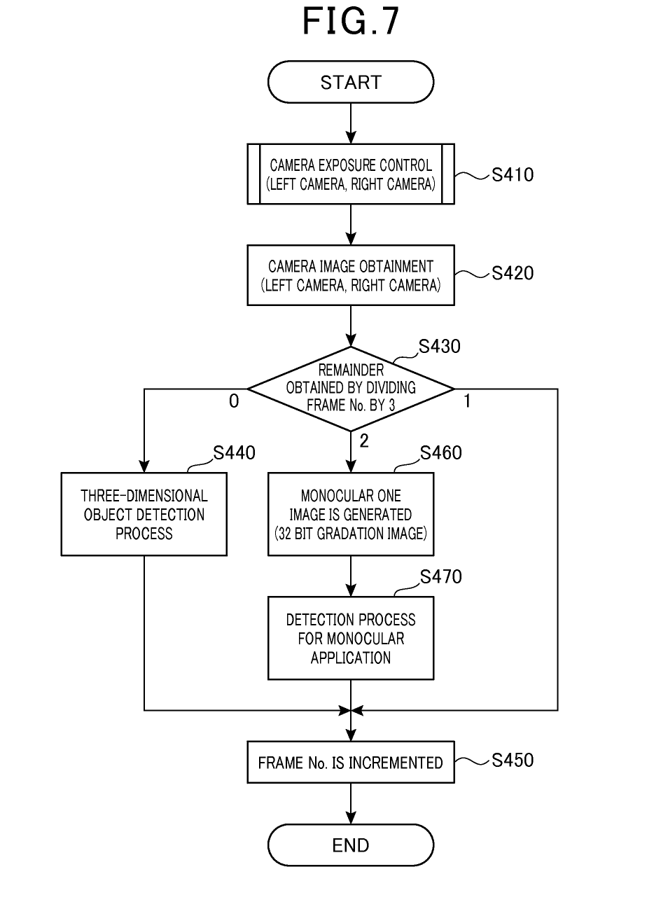

The process performed by the stereo image sensor 1 is explained based on the flowcharts in FIGS. 7 to 9.

The stereo image sensor 1 repeats the process shown in the flowchart in FIG. 7 at intervals of 33 msec.

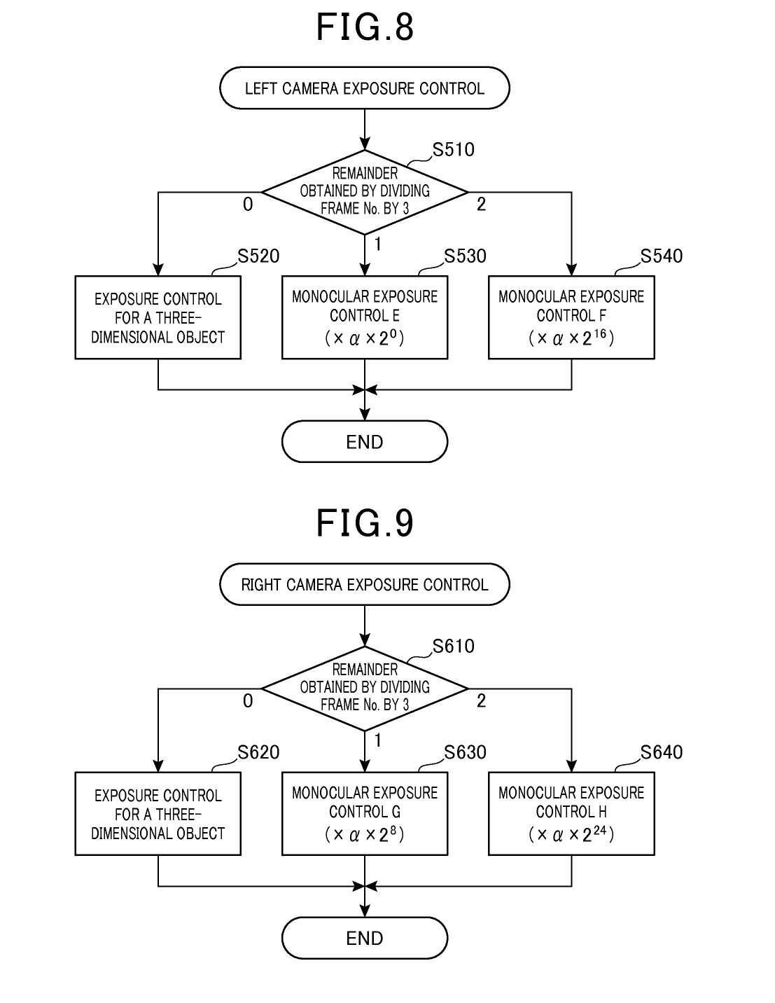

In step 410, exposure controls of the right camera 3 and the left camera 5 are performed. First, exposure control of the left camera 5 is explained based on the flowchart in FIG. 8.

In step 510, a frame No. of an image captured most recently is obtained to calculate X which is a remainder (any one of 0, 1, 2) obtained when dividing the frame No. by 3. Here, the meaning of the frame No. is similar to that in the first embodiment.

If the value of X is 0, the process proceeds to step 520, in which an exposure control for a three-dimensional object is set for the left camera 5. This exposure control for a three-dimensional object is an exposure control suited for a three-dimensional object detection process.

Meanwhile, if the value of X is 1, the process proceeds to step 530, in which a monocular exposure control (a type of exposure control for recognizing an object placed on a road and a lamp) E is set for the left camera 5. This monocular exposure control E is a control for setting exposure of the left camera 5 to be exposure suited for recognizing a lane (white line) on a road. In addition, under the monocular exposure control E, brightness of an image is expressed by α×2⁰.

In addition, if the value of X is 2, the process proceeds to step 540, in which a monocular exposure control (a type of exposure control for recognizing an object placed on a road and a lamp) F is set for the left camera 5. This monocular exposure control F is a control for setting exposure of the left camera 5 to be exposure suited for recognizing a lane (white line) on a road. In addition, under the monocular exposure control F, brightness of an image is expressed by α×2¹⁶, which is 2¹⁶ times higher than the brightness (α×2⁰) under the monocular exposure control E.

Next, exposure control of the right camera 3 is explained based of the flowchart in FIG. 9.

In step 610, a frame No. of an image captured most recently is obtained to calculate X which is a remainder (any one of 0, 1, 2) obtained when dividing the frame No. by 3. Note that the right camera 3 and the left camera 5 simultaneously perform imaging at any time. Hence, the frame No. of an image captured by the right camera 3 most recently is the same as the frame No. of an image captured by the left camera 5 most recently.

If the value of X is 0, the process proceeds to step 620, in which an exposure control for a three-dimensional object is set for the right camera 3. This exposure control for a three-dimensional object is an exposure control suited for the three-dimensional object detection process.

Meanwhile, if the value of X is 1, the process proceeds to step 630, in which a monocular exposure control (a type of exposure control for recognizing an object placed on a road and a lamp) G is set for the right camera 3. This monocular exposure control G is a control for setting exposure of the right camera 3 to be exposure suited for recognizing a lane (white line) on a road. In addition, under the monocular exposure control G, brightness of an image is expressed by α×2⁸, which is 2⁸ times higher than the brightness (α×2⁰) under the monocular exposure control E.

In addition, if the value of X is 2, the process proceeds to step 640, in which a monocular exposure control (a type of exposure control for recognizing an object placed on a road and a lamp) H is set for the right camera 3. This monocular exposure control H is a control for setting exposure of the right camera 3 to be exposure suited for recognizing a lane (white line) on a road. In addition, under the monocular exposure control H, brightness of an image is expressed by α×2²⁴, which is 2²⁴ times higher than the brightness (α×2⁰) under the monocular exposure control E.

Returning to FIG. 7, in step 420, the front of the vehicle is imaged by the right camera 3 and the left camera 5 to obtain images thereof. Note that the right camera 3 and the left camera 5 simultaneously perform imaging.

In step 430, it is determined whether X calculated in the immediately preceding steps 510 and 610 is 0, 1, or 2. If X is 0, the process proceeds to step 440, in which the three-dimensional object detection process is performed. Note that the case where X is 0 is a case where exposure controls of the right camera 3 and the left camera 5 are set to the exposure control for a three-dimensional object, and imaging is performed under the condition thereof. The contents of the three-dimensional object detection process are similar to those of the first embodiment.

In step S450, the frame No. is incremented by one.

Meanwhile, if it is determined that X is 1 in the step 430, the process proceeds to step 450, in which the frame No. is incremented by one.

Meanwhile, if it is determined that X is 2 in the step 430, the process proceeds to step 460. Note that the case where X is 2 is a case where, in the steps 540, 640, exposure controls of the right camera 3 and the left camera 5 are respectively set to the monocular exposure controls H, F to perform imaging under the conditions thereof.

In step 460, the following four images are combined to generate a synthetic image R.
an image captured by the right camera 3 when X is 1 most recently (an image captured under the monocular exposure control G)
an image captured by the left camera 5 when X is 1 most recently (an image captured under the monocular exposure control E)
an image captured by the right camera 3 when X is 2 (immediately preceding step 420) (an image captured under the monocular exposure control H)
an image captured by the left camera 5 when X is 2 (immediately preceding step 420) (an image captured under the monocular exposure control F)

The synthetic image R is generated by summing a pixel value of each pixel of the four images for each pixel. That is, the pixel value of each pixel of the synthetic image R is [0086] the sum of the pixel value of each corresponding pixel of the four images.

Each of the four images is 8 bit data. In addition, compared with the image captured under the monocular exposure control E, brightness of the image captured under the monocular exposure control G is 2⁸ times higher, brightness of the image captured under the monocular exposure control F is 2¹⁶ times higher, and brightness of the image captured under the monocular exposure control H is 2²⁴ times higher. Hence, the pixel values of respective pixels are summed after the pixel values are individually multiplied by 2⁸, 2¹⁶, and 2²⁴. In addition, as a result, the synthetic image R becomes 32 bit data. The dynamic range of the synthetic image R is 2²⁴ larger compared with the image captured by the right camera 3 or the image captured by the left camera 5.

In step 470, a process is performed in which a lane (white line) is detected from the synthetic image R combined in the step 460. Specifically, in the synthetic image R, points at which the variation of brightness is equal to or more than a predetermined value (edge points) are retrieved to generate an image of the edge points (edge image). Then, in the edge image, a lane (white line) is detected from a shape of an area formed with the edge points by a known technique such as matching.

After step 470 is completed, the process proceeds to step 450, in which the frame No. is incremented by one.

3. Advantages Provided by the Stereo Image Sensor 1

The stereo image sensor 1 combines the two images captured by the right camera 3 and the two images captured by the left camera to generate the synthetic image R having a larger dynamic range, and detects an object placed on a road or a lamp from the synthetic image R. Hence, it is difficult to cause a state where the object placed on a road and the lamp cannot be detected due to the lack of the dynamic range of the image.

### Fourth Embodiment

1. Configuration of the Stereo Image Sensor 1

The configuration of the stereo image sensor 1 is similar to that of the first embodiment.

2. Process Performed by the Stereo Image Sensor 1

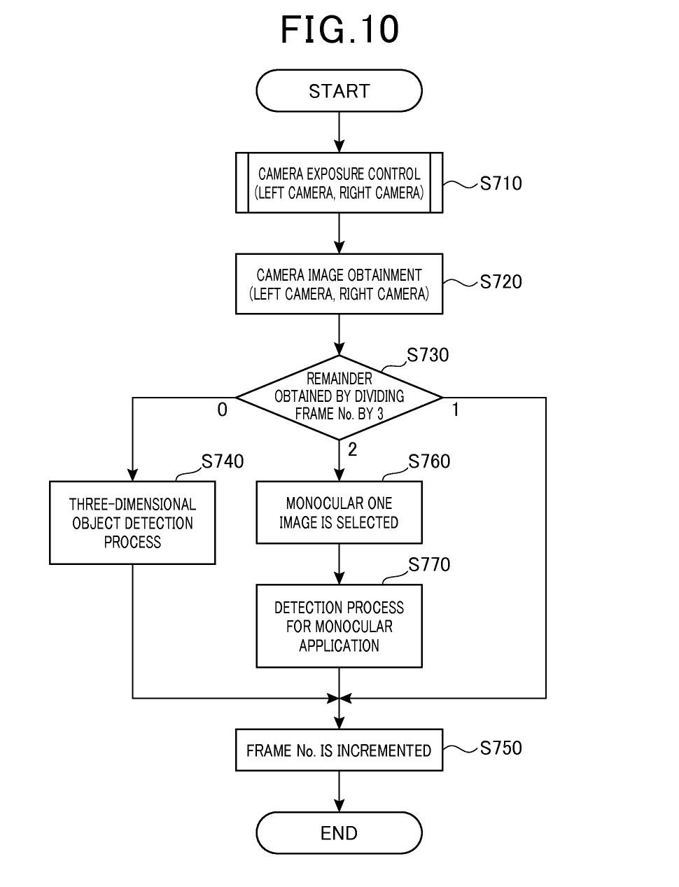

The process performed by the stereo image sensor 1 is explained based on the flowchart in FIG. 10.

The stereo image sensor 1 repeats the process shown in the flowchart in FIG. 10 at intervals of 33 msec.

In step 710, exposure controls of the right camera 3 and the left camera 5 are performed. The exposure controls are similar to those of the third embodiment.

In step 720, the front of the vehicle is imaged by the right camera 3 and the left camera 5 to obtain images thereof. Note that the right camera 3 and the left camera 5 simultaneously perform imaging.

In step 730, a frame No. of an image captured most recently is obtained to determine whether X, which is a remainder obtained when dividing the frame No. by 3, is 0, 1, or 2. If X is 0, the process proceeds to step 740, in which the three-dimensional object detection process is performed. The contents of the three-dimensional object detection process are similar to those of the first embodiment.

In step S750, the frame No. is incremented by one.

Meanwhile, if it is determined that X is 1 in the step 730, the process proceeds to step 750, in which the frame No. is incremented by one. Note that the case where X is 1 is a case where exposure controls of the right camera 3 and the left camera 5 are respectively set to the monocular exposure control G, E to perform imaging under the conditions thereof.

Meanwhile, if it is determined that X is 2 in the step 730, the process proceeds to step 760. Note that the case where X is 2 is a case where exposure controls of the right camera 3 and the left camera 5 are respectively set to the monocular exposure control H, F to perform imaging under the conditions thereof.

In step 760, an image having the highest contrast is selected from the following four images.
an image captured by the right camera 3 when X is 1 most recently (an image captured under the monocular exposure control G)
an image captured by the left camera 5 when X is 1 most recently (an image captured under the monocular exposure control E)
an image captured by the right camera 3 when X is 2 (immediately preceding step 420) (an image captured under the monocular exposure control H)
an image captured by the left camera 5 when X is 2 (immediately preceding step 420) (an image captured under the monocular exposure control F)

Specifically, the selection of the image having the highest contrast is performed as below. In each of the four images, points at which the variation of brightness is equal to or more than a predetermined value (edge points) are retrieved to generate an image of the edge points (edge image). Then, the edge images of the four images are compared with each other to determine which edge image has the most edge points. Of the four images, the image having the most edge points is selected as an image having the highest contrast.

Each of the four images is 8 bit data. In addition, compared with the image captured under the monocular exposure control E, brightness of the image captured under the monocular exposure control G is 2⁸ times higher, brightness of the image captured under the monocular exposure control F is 2¹⁶ times higher, and brightness of the image captured under the monocular exposure control H is 2²⁴ times higher. As a result, the combination of the four images covers the dynamic range 2²⁴ times larger compared with the image captured by the right camera 3 or the image captured by the left camera 5.

In step 770, a process is performed in which a lane (white line) is detected from the image selected in the step 760. Specifically, in the image selected in the step 760, points at which the variation of brightness is equal to or more than a predetermined value (edge points) are retrieved to generate an image of the edge points (edge image). Then, in the edge image, a lane (white line) is detected from a shape of an area formed with the edge points by a known technique such as matching.

After step 770 is completed, the process proceeds to step 750, in which the frame No. is incremented by one.

3. Advantages Provided by the Stereo Image Sensor 1

The stereo image sensor 1 selects the image having the highest contrast from the two images captured by the right camera 3 and the two images captured by the left camera, and detects an object placed on a road or a lamp from the selected image. Hence, it is difficult to cause a state where the object placed on a road and the lamp cannot be detected due to the lack of the dynamic range of the image.

Note that the present invention is not limited to the above embodiments at all and, needless to say, can be implemented in various embodiments, as far as the embodiments do not depart from the spirit of the present invention.

For example, instead of the processes of the steps 360, 370 in the second embodiment, a first object placed on a road or lamp may be detected from an image captured by the right camera 3 (an image captured under the monocular exposure control C), and a second object placed on a road or lamp may be detected from an image captured by the left camera 5 (an image captured under the monocular exposure control A). Furthermore, instead of the processes of the steps 380, 390 in the second embodiment, a third object placed on a road or lamp may be detected from an image captured by the right camera 3 (an image captured under the monocular exposure control D), and a fourth object placed on a road or lamp may be detected from an image captured by the left camera 5 (an image captured under the monocular exposure control B). The first to fourth objects placed on a road or lamps can optionally be set from, for example, a white line, a sign, a traffic light, and lamps of another vehicle.

In the first and third embodiments, the number of images to be combined is not limited to 2 and 4 and can be any number (e.g. 3, 5, 6, 7, 8, . . . ).

In the second and fourth embodiments, the selection of an image may be performed from images the number of which is other than 2 and 4 (e.g. 3, 5, 6, 7, 8, . . . ).

### DESCRIPTION OF THE REFERENCE NUMERALS

1 . . . stereo image sensor, 3 . . . right camera, 5 . . . left camera, 7 . . . CPU, 9 . . . vehicle control unit, 11 . . . alarm unit

1. An image processing apparatus for a vehicle, comprising:
a first imaging section;
a second imaging section;
a switching section which switches exposure controls of the first imaging section and the second imaging section to an exposure control for recognizing an object placed on a road and a lamp or to an exposure control for recognizing a three-dimensional object; and
a detection section which detects the object placed on a road and the lamp or the three-dimensional object from images captured by the first imaging section and the second imaging section, wherein
under the exposure control for recognizing an object placed on a road and a lamp, exposure of the first imaging section and exposure of the second imaging section are different from each other.

2. The image processing apparatus for a vehicle according to claim 1, wherein
when the exposure control for recognizing an object placed on a road and a lamp is performed, the first imaging section and the second imaging section simultaneously perform imaging.

3. The image processing apparatus for a vehicle according to claim 1, wherein
under the exposure control for recognizing an object placed on a road and a lamp, a dynamic range of the first imaging section and a dynamic range of the second imaging section overlap with each other.

4. The image processing apparatus for a vehicle according to claim 1, wherein
the detection section combines images captured by the first imaging section and the second imaging section when the exposure control for recognizing an object placed on a road and a lamp is performed, and detects the object placed on a road or the lamp from the combined image.

5. The image processing apparatus for a vehicle according to claim 1, wherein
the detection section selects an image having a higher contrast from an image captured by the first imaging section when the exposure control for recognizing an object placed on a road and a lamp is performed and an image captured by the second imaging section when the exposure control for recognizing an object placed on a road and a lamp is performed, and detects the object placed on a road or the lamp from the selected image.

6. The image processing apparatus for a vehicle according to claim 1, wherein
the exposure control for recognizing an object placed on a road and a lamp includes two or more types of controls having different conditions of exposure.
